(19) United States
(12) Patent Application Publication
(10) Pub. No.: US 2024/0143363 A1
(43) Pub. Date: May 2, 2024

(54) VIRTUAL MACHINE TUNNELING MECHANISM

(71) Applicant: Intel Corporation, Santa Clara, CA (US)

(72) Inventor: Reshma Lal, Portland, OR (US)

(73) Assignee: Intel Corporation, Santa Clara, CA (US)

(21) Appl. No.: 17/974,035

(22) Filed: Oct. 26, 2022

(51) Int. Cl. G06F 9/455

(52) U.S. Cl. CPC G06F 9/45558; G06F 2009/45579; G06F 2009/45583; G06F 2009/45591; G06F 2009/45595

(57) ABSTRACT

An apparatus comprising a memory device, a system on chip (SoC), including a central processing unit (CPU) to execute a virtual machine to retrieve data from the memory device and transmit the data to a remote input/output (I/O) device coupled to a remote computing platform as memory transaction data; and a port to transmit the memory transaction data as transaction layer packets (TLPs) and a network interface card (NIC) to receive the TLPs, including an interface to receive the TLPs and packet conversion hardware to convert the TLPs to network protocol packets and transmit the network protocol packets to the remote I/O memory device.

### BACKGROUND

Applications are increasingly running on public cloud datacenters, which comprises multiple platforms and devices connected in a network. Maintaining data confidentiality during the transport of data between platforms is important to maintain datacenter security.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a computing device for secure I/O with an accelerator device;

FIG. 2 is a simplified block diagram of at least one embodiment of an accelerator device of the computing device of FIG. 1;

FIG. 3 is a simplified block diagram of at least one embodiment of an environment of the computing device of FIGS. 1 and 2;

FIG. 4 illustrates a computing device according to implementations of the disclosure;

FIG. 5 illustrates one embodiment of a computing platform;

FIG. 6A illustrates conventional access control of remote devices;

FIG. 6B illustrates conventional of platform buffers;

FIG. 7 illustrates one embodiment of a network;

FIG. 8 is a flow diagram illustrating one embodiment of a secure data flow configuration process; and

FIG. 9 is a flow diagram illustrating one embodiment of a process to perform secure data flow.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

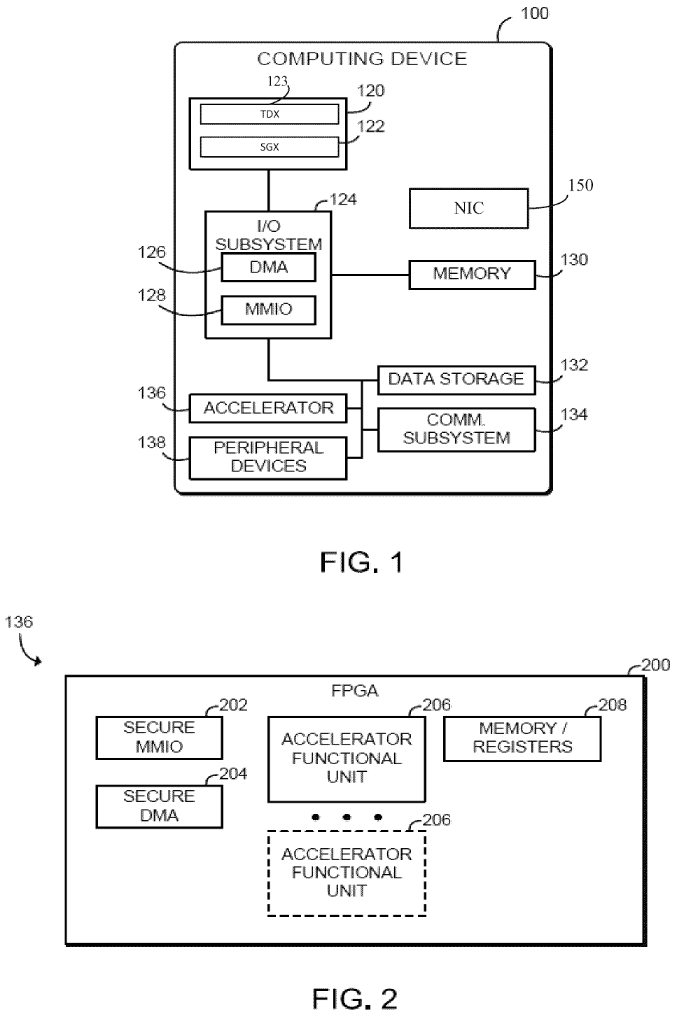

Referring now to FIG. 1, a computing device 100 for secure I/O with an accelerator device includes a processor 120 and an accelerator device (or accelerator) 136, such as a field-programmable gate array (FPGA). In use, as described further below, a trusted execution environment (TEE) established by the processor 120 securely communicates data with the accelerator 136. Data may be transferred using memory-mapped I/O (MMIO) transactions or direct memory access (DMA) transactions. For example, the TEE may perform an MMIO write transaction that includes encrypted data, and the accelerator 136 decrypts the data and performs the write. As another example, the TEE may perform an MMIO read request transaction, and the accelerator 136 may read the requested data, encrypt the data, and perform an MMIO read response transaction that includes the encrypted data. As yet another example, the TEE may configure the accelerator 136 to perform a DMA operation, and the accelerator 136 performs a memory transfer, performs a cryptographic operation (i.e., encryption or decryption), and forwards the result. As described further below, the TEE and the accelerator 136 generate authentication tags (ATs) for the transferred data and may use those ATs to validate the transactions. The computing device 100 may thus keep untrusted software of the computing device 100, such as the operating system or virtual machine monitor, outside of the trusted code base (TCB) of the TEE and the accelerator 136. Thus, the computing device 100 may secure data exchanged or otherwise processed by a TEE and an accelerator 136 from an owner of the computing device 100 (e.g., a cloud service provider) or other tenants of the computing device 100. Accordingly, the computing device 100 may improve security and performance for multi-tenant environments by allowing secure use of accelerator devices.

The computing device 100 may be embodied as any type of device capable of performing the functions described herein. For example, the computing device 100 may be embodied as, without limitation, a computer, a laptop computer, a tablet computer, a notebook computer, a mobile computing device, a smartphone, a wearable computing device, a multiprocessor system, a server, a workstation, and/or a consumer electronic device. As shown in FIG. 1, the illustrative computing device 100 includes a processor 120, an I/O subsystem 124, a memory 130, and a data storage device 132. Additionally, in some embodiments, one or more of the illustrative components may be incorporated in, or otherwise form a portion of, another component. For example, the memory 130, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. As shown, the processor 120 illustratively includes secure enclave support 122, which allows the processor 120 to establish a trusted execution environment known as a secure enclave, in which executing code may be measured, verified, and/or otherwise determined to be authentic. Additionally, code and data included in the secure enclave may be encrypted or otherwise protected from being accessed by code executing outside of the secure enclave. For example, code and data included in the secure enclave may be protected by hardware protection mechanisms of the processor 120 while being executed or while being stored in certain protected cache memory of the processor 120. The code and data included in the secure enclave may be encrypted when stored in a shared cache or the main memory 130. The secure enclave support 122 may be embodied as a set of processor instruction extensions that allows the processor 120 to establish one or more secure enclaves in the memory 130. For example, the secure enclave support 122 may be embodied as Intel® Software Guard Extensions (SGX) technology. In other embodiments, processor 120 may include trusted domains (TDs) 123 embodied as Intel® Trusted Domain Extensions (TDX) technology that is implemented to isolate virtual machines from the virtual machine monitor and other virtual machines operating on the computing device 100.

The memory 130 may be embodied as any type of volatile or non-volatile memory or data storage capable of performing the functions described herein. In operation, the memory 130 may store various data and software used during operation of the computing device 100 such as operating systems, applications, programs, libraries, and drivers. As shown, the memory 130 may be communicatively coupled to the processor 120 via the I/O subsystem 124, which may be embodied as circuitry and/or components to facilitate input/output operations with the processor 120, the memory 130, and other components of the computing device 100. For example, the I/O subsystem 124 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations. In some embodiments, the memory 130 may be directly coupled to the processor 120, for example via an integrated memory controller hub. Additionally, in some embodiments, the I/O subsystem 124 may form a portion of a system-on-a-chip (SoC) and be incorporated, along with the processor 120, the memory 130, the accelerator 136, and/or other components of the computing device 100, on a single integrated circuit chip. Additionally, or alternatively, in some embodiments the processor 120 may include an integrated memory controller and a system agent, which may be embodied as a logic block in which data traffic from processor cores and I/O devices converges before being sent to the memory 130.

As shown, the I/O subsystem 124 includes a direct memory access (DMA) engine 126 and a memory-mapped I/O (MMIO) engine 128. The processor 120, including secure enclaves established with the secure enclave support 122, may communicate with the accelerator 136 with one or more DMA transactions using the DMA engine 126 and/or with one or more MMIO transactions using the MMIO engine 128. The computing device 100 may include multiple DMA engines 126 and/or MMIO engines 128 for handling DMA and MMIO read/write transactions based on bandwidth between the processor 120 and the accelerator 136. Although illustrated as being included in the I/O subsystem 124, it should be understood that in some embodiments the DMA engine 126 and/or the MMIO engine 128 may be included in other components of the computing device 100 (e.g., the processor 120, memory controller, or system agent), or in some embodiments may be embodied as separate components.

The data storage device 132 may be embodied as any type of device or devices configured for short-term or long-term storage of data such as, for example, memory devices and circuits, memory cards, hard disk drives, solid-state drives, non-volatile flash memory, or other data storage devices. The computing device 100 may also include a communications subsystem 134, which may be embodied as any communication circuit, device, or collection thereof, capable of enabling communications between the computing device 100 and other remote devices over a computer network (not shown). The communications subsystem 134 may be configured to use any one or more communication technology (e.g., wired or wireless communications) and associated protocols (e.g., Ethernet, Bluetooth®, Wi-Fi®, WiMAX, 3G, 4G LTE, etc.) to effect such communication.

The accelerator 136 may be embodied as a field-programmable gate array (FPGA), an application-specific integrated circuit (ASIC), a coprocessor, or other digital logic device capable of performing accelerated functions (e.g., accelerated application functions, accelerated network functions, or other accelerated functions), GPUs, etc. Illustratively, the accelerator 136 is an FPGA, which may be embodied as an integrated circuit including programmable digital logic resources that may be configured after manufacture. The FPGA may include, for example, a configurable array of logic blocks in communication over a configurable data interchange. The accelerator 136 may be coupled to the processor 120 via a high-speed connection interface such as a peripheral bus (e.g., a PCI Express (PCIe) bus) or an inter-processor interconnect (e.g., an in-die interconnect (IDI) or QuickPath Interconnect (QPI)), or via any other appropriate interconnect. The accelerator 136 may receive data and/or commands for processing from the processor 120 and return results data to the processor 120 via DMA, MMIO, or other data transfer transactions.

As shown, the computing device 100 may further include one or more peripheral devices 138. The peripheral devices 138 may include any number of additional input/output devices, interface devices, hardware accelerators, and/or other peripheral devices. For example, in some embodiments, the peripheral devices 138 may include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices.

The computing device 100 may also include a network interface controller (NIC) 150. NIC 150 enables computing device 100 to communicate with another computing device 100 via a network. In embodiments, NIC 150 may comprise a programmable (or smart) NIC, infrastructure processing unit (IPU), or datacenter processing unit (DPU) that may be configured to perform different actions based on a type of packet, connection, or other packet characteristic.

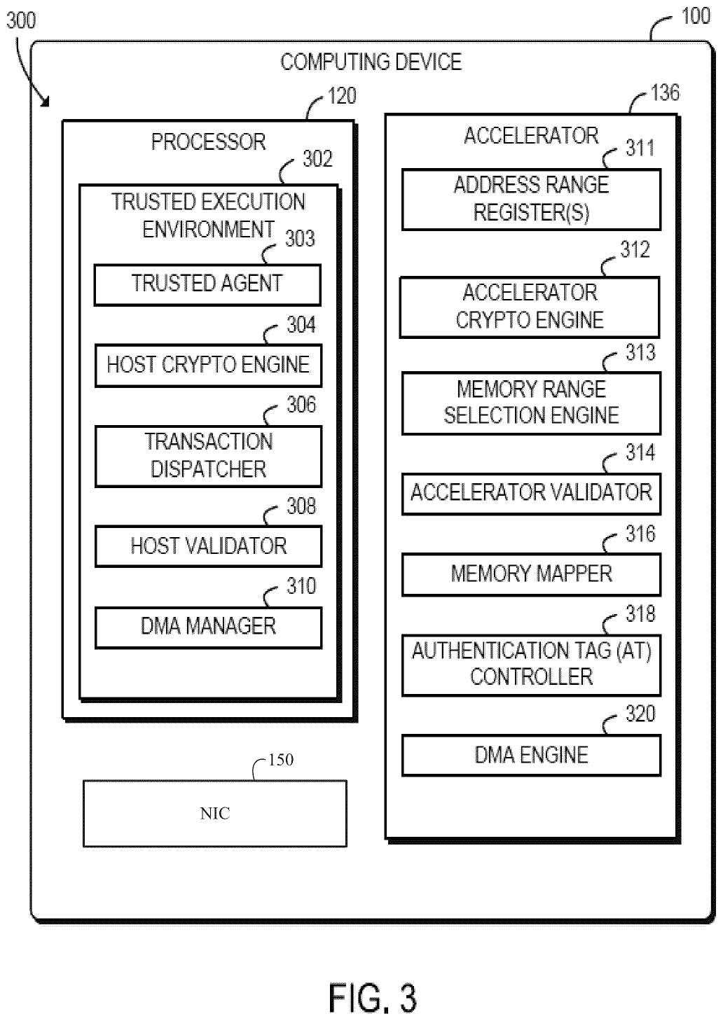

Referring now to FIG. 2, an illustrative embodiment of a field-programmable gate array (FPGA) 200 is shown. As shown, the FPGA 200 is one potential embodiment of an accelerator 136. The illustratively FPGA 200 includes a secure MMIO engine 202, a secure DMA engine 204, one or more accelerator functional units (AFUs) 206, and memory/registers 208. As described further below, the secure MMIO engine 202 and the secure DMA engine 204 perform in-line authenticated cryptographic operations on data transferred between the processor 120 (e.g., a secure enclave established by the processor) and the FPGA 200 (e.g., one or more AFUs 206). In some embodiments, the secure MMIO engine 202 and/or the secure DMA engine 204 may intercept, filter, or otherwise process data traffic on one or more cache-coherent interconnects, internal buses, or other interconnects of the FPGA 200.

Each AFU 206 may be embodied as logic resources of the FPGA 200 that are configured to perform an acceleration task. Each AFU 206 may be associated with an application executed by the computing device 100 in a secure enclave or other trusted execution environment. Each AFU 206 may be configured or otherwise supplied by a tenant or other user of the computing device 100. For example, each AFU 206 may correspond to a bitstream image programmed to the FPGA 200. As described further below, data processed by each AFU 206, including data exchanged with the trusted execution environment, may be cryptographically protected from untrusted components of the computing device 100 (e.g., protected from software outside of the trusted code base of the tenant enclave). Each AFU 206 may access or otherwise process stored in the memory/registers 208, which may be embodied as internal registers, cache, SRAM, storage, or other memory of the FPGA 200. In some embodiments, the memory/registers 208 may also include external DRAM or other dedicated memory coupled to the FPGA 200.

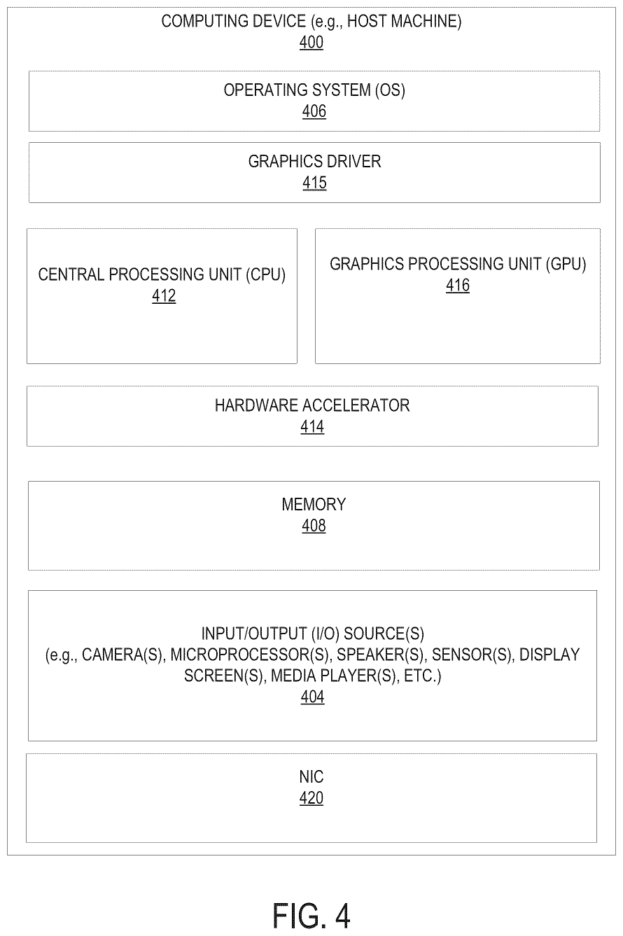

Referring now to FIG. 3, in an illustrative embodiment, the computing device 100 establishes an environment 300 during operation. The illustrative environment 300 includes a trusted execution environment (TEE) 302 and the accelerator 136. The TEE 302 further includes a trusted agent 303, host cryptographic engine 304, a transaction dispatcher 306, a host validator 308, and a direct memory access (DMA) manager 310. The accelerator 136 includes an accelerator cryptographic engine 312, a memory range selection engine 313, an accelerator validator 314, a memory mapper 316, an authentication tag (AT) controller 318, and a DMA engine 320. The various components of the environment 300 may be embodied as hardware, firmware, software, or a combination thereof. As such, in some embodiments, one or more of the components of the environment 300 may be embodied as circuitry or collection of electrical devices (e.g., host cryptographic engine circuitry 304, transaction dispatcher circuitry 306, host validator circuitry 308, DMA manager circuitry 310, accelerator cryptographic engine circuitry 312, accelerator validator circuitry 314, memory mapper circuitry 316, AT controller circuitry 318, and/or DMA engine circuitry 320). It should be appreciated that, in such embodiments, one or more of the host cryptographic engine circuitry 304, the transaction dispatcher circuitry 306, the host validator circuitry 308, the DMA manager circuitry 310, the accelerator cryptographic engine circuitry 312, the accelerator validator circuitry 314, the memory mapper circuitry 316, the AT controller circuitry 318, and/or the DMA engine circuitry 320 may form a portion of the processor 120, the I/O subsystem 124, the accelerator 136, and/or other components of the computing device 100. Additionally, in some embodiments, one or more of the illustrative components may form a portion of another component and/or one or more of the illustrative components may be independent of one another.

The TEE 302 may be embodied as a trusted execution environment of the computing device 100 that is authenticated and protected from unauthorized access using hardware support of the computing device 100, such as the secure enclave support 122 of the processor 120. Illustratively, the TEE 302 may be embodied as one or more secure enclaves established using Intel® SGX technology or TDs established using Intel® TDX technology. The TEE 302 may also include or otherwise interface with one or more drivers, libraries, or other components of the computing device 100 to interface with the accelerator 136.

The host cryptographic engine 304 is configured to generate an authentication tag (AT) based on a MMIO transaction and to write that AT to an AT register of the accelerator 136. For an MMIO write request, the host cryptographic engine 304 is further configured to encrypt a data item to generate an encrypted data item, and the AT is generated in response to encrypting the data item. For an MMIO read request, the AT is generated based on an address associated with MMIO read request.

The transaction dispatcher 306 is configured to dispatch the memory-mapped I/O transaction (e.g., an MMIO write request or an MMIO read request) to the accelerator 136 after writing the calculated AT to the AT register. An MMIO write request may be dispatched with the encrypted data item.

The host validator 308 may be configured to verify that an MMIO write request succeeded in response dispatching the MMIO write request. Verifying that the MMIO write request succeeded may include securely reading a status register of the accelerator 136, securely reading a value at the address of the MMIO write from the accelerator 136, or reading an AT register of the accelerator 136 that returns an AT value calculated by the accelerator 136, as described below. For MMIO read requests, the host validator 308 may be further configured to generate an AT based on an encrypted data item included in a MMIO read response dispatched from the accelerator 136; read a reported AT from a register of the accelerator 136; and determine whether the AT generated by the TEE 302 matches the AT reported by the accelerator 136. The host validator 308 may be further configured to indicate an error if those ATs do not match, which provides assurance that data was not modified on the way from the TEE 302 to the accelerator 136.

The accelerator cryptographic engine 312 is configured to perform a cryptographic operation associated with the MMIO transaction and to generate an AT based on the MMIO transaction in response to the MMIO transaction being dispatched. For an MMIO write request, the cryptographic operation includes decrypting an encrypted data item received from the TEE 302 to generate a data item, and the AT is generated based on the encrypted data item. For an MMIO read request, the cryptographic operation includes encrypting a data item from a memory of the accelerator 136 to generate an encrypted data item, and the AT is generated based on that encrypted data item.

The accelerator validator 314 is configured to determine whether the AT written by the TEE 302 matches the AT determined by the accelerator 136. The accelerator validator 314 is further configured to drop the MMIO transaction if those ATs do not match. For MMIO read requests, the accelerator validator 314 may be configured to generate a poisoned AT in response to dropping the MMIO read request, and may be further configured to dispatch a MMIO read response with a poisoned data item to the TEE 302 in response to dropping the MMIO read request.

The memory mapper 316 is configured to commit the MMIO transaction in response to determining that the AT written by the TEE 302 matches the AT generated by the accelerator 136. For an MMIO write request, committing the transaction may include storing the data item in a memory of the accelerator 136. The memory mapper 316 may be further configured to set a status register to indicate success in response to storing the data item. For an MMIO read request, committing the transaction may include reading the data item at the address in the memory of the accelerator 136 and dispatching an MMIO read response with the encrypted data item to the TEE 302.

The DMA manager 310 is configured to securely write an initialization command to the accelerator 136 to initialize a secure DMA transfer. The DMA manager 310 is further configured to securely configure a descriptor indicative of a host memory buffer, an accelerator 136 buffer, and a transfer direction. The transfer direction may be host to accelerator 136 or accelerator 136 to host. The DMA manager 310 is further configured to securely write a finalization command to the accelerator 136 to finalize an authentication tag (AT) for the secure DMA transfer. The initialization command, the descriptor, and the finalization command may each be securely written and/or configured with an MMIO write request. The DMA manager 310 may be further configured to determine whether to transfer additional data in response to securely configuring the descriptor, the finalization command may be securely written in response to determining that no additional data remains for transfer.

The AT controller 318 is configured to initialize an AT in response to the initialization command from the TEE 302. The AT controller 318 is further configured to finalize the AT in response to the finalization command from the TEE 302.

The DMA engine 320 is configured to transfer data between the host memory buffer and the accelerator 136 buffer in response to the descriptor from the TEE 302. For a transfer from host to accelerator 136, transferring the data includes copying encrypted data from the host memory buffer and forwarding the plaintext data to the accelerator 136 buffer in response to decrypting the encrypted data. For a transfer from accelerator 136 to host, transferring the data includes copying plaintext data from the accelerator 136 buffer and forwarding encrypted data to the host memory buffer in response encrypting the plaintext data.

The accelerator cryptographic engine 312 is configured to perform a cryptographic operation with the data in response to transferring the data and to update the AT in response to transferring the data. For a transfer from host to accelerator 136, performing the cryptographic operation includes decrypting encrypted data to generate plaintext data. For a transfer from accelerator 136 to host, performing the cryptographic operation includes encrypting plaintext data to generate encrypted data.

The host validator 308 is configured to determine an expected AT based on the secure DMA transfer, to read the AT from the accelerator 136 in response to securely writing the finalization command, and to determine whether the AT from the accelerator 136 matches the expected AT. The host validator 308 may be further configured to indicate success if the ATs match and to indicate failure if the ATs do not match.

According to one embodiment, NIC 150 may comprise an accelerator 136. In such an embodiment, NIC 150 operates as a network interface accelerator/controller.

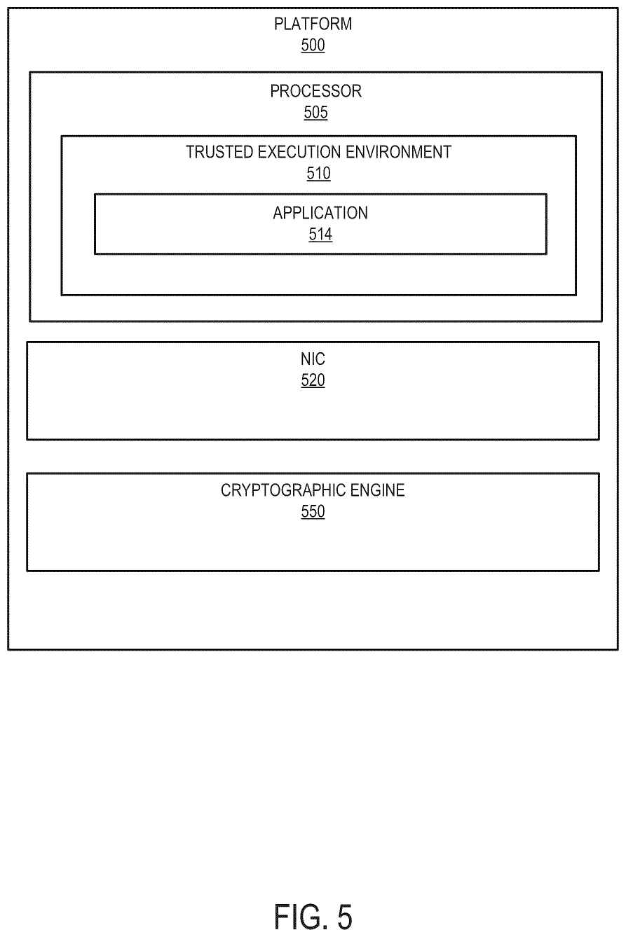

FIG. 4 illustrates another embodiment of a computing device 400. Computing device 400 represents a communication and data processing device including or representing (without limitations) smart voice command devices, intelligent personal assistants, home/office automation system, home appliances (e.g., washing machines, television sets, etc.), mobile devices (e.g., smartphones, tablet computers, etc.), gaming devices, handheld devices, wearable devices (e.g., smartwatches, smart bracelets, etc.), virtual reality (VR) devices, head-mounted display (HMDs), Internet of Things (IoT) devices, laptop computers, desktop computers, server computers, set-top boxes (e.g., Internet based cable television set-top boxes, etc.), global positioning system (GPS)-based devices, automotive infotainment devices, etc.

In some embodiments, computing device 400 includes or works with or is embedded in or facilitates any number and type of other smart devices, such as (without limitation) autonomous machines or artificially intelligent agents, such as a mechanical agents or machines, electronics agents or machines, virtual agents or machines, electromechanical agents or machines, etc. Examples of autonomous machines or artificially intelligent agents may include (without limitation) robots, autonomous vehicles (e.g., self-driving cars, self-flying planes, self-sailing boats, etc.), autonomous equipment self-operating construction vehicles, self-operating medical equipment, etc.), and/or the like. Further, “autonomous vehicles” are not limed to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, computing device 400 may include a computer platform hosting an integrated circuit (“IC”), such as a system on a chip (“SOC” or “SOC”), integrating various hardware and/or software components of computing device 400 on a single chip.

As illustrated, in one embodiment, computing device 400 may include any number and type of hardware and/or software components, such as (without limitation) graphics processing unit (“GPU” or simply “graphics processor”) 416, graphics driver (also referred to as “GPU driver”, “graphics driver logic”, “driver logic”, user-mode driver (UMD), user-mode driver framework (UMDF), or simply “driver”) 415, central processing unit (“CPU” or simply “application processor”) 412, hardware accelerator 414 (such as an FPGA, ASIC, a re-purposed CPU, or a re-purposed GPU, for example), memory 408, network devices, drivers, or the like, as well as input/output (I/O) sources 404, such as touchscreens, touch panels, touch pads, virtual or regular keyboards, virtual or regular mice, ports, connectors, etc. Computing device 400 may include operating system (OS) 406 serving as an interface between hardware and/or physical resources of the computing device 400 and a user. Computing device 400 also includes a NIC 420.

It is to be appreciated that a lesser or more equipped system than the example described above may be utilized for certain implementations. Therefore, the configuration of computing device 400 may vary from implementation to implementation depending upon numerous factors, such as price constraints, performance requirements, technological improvements, or other circumstances.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The terms “logic”, “module”, “component”, “engine”, “circuitry”, “element”, and “mechanism” may include, by way of example, software, hardware and/or a combination thereof, such as firmware.

Computing device 400 may host network interface device(s) to provide access to a network, such as a LAN, a wide area network (WAN), a metropolitan area network (MAN), a personal area network (PAN), Bluetooth, a cloud network, a mobile network (e.g., 3rd Generation (3G), 4th Generation (4G), etc.), an intranet, the Internet, etc. Network interface(s) may include, for example, a wireless network interface having antenna, which may represent one or more antenna(s). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media having stored thereon machine executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMS, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

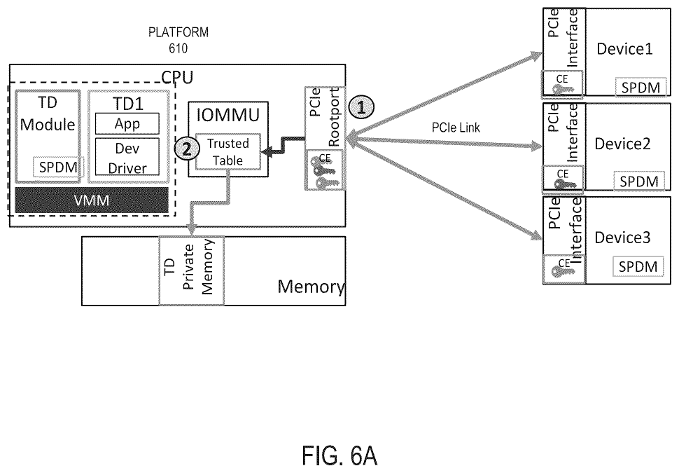

FIG. 5 illustrates a block diagram depicting one embodiment of a platform 500. In one implementation, the illustrative platform 500 may include a processor 505 to establish a TEE 510 during operation. The platform 500 may be the same as computing device 100 described with respect to FIGS. 1 and 2, and computing device 400 in FIG. 4, for example. The establishment of the TEE 510 may be in line with the discussion above with respect to FIG. 3 of establishing a TEE and such discussion applies similarly here with respect to FIG. 5.

As illustrated, the TEE 510 further includes an application 514. The various components of the platform 500 may be embodied as hardware, firmware, software, or a combination thereof. As such, in some embodiments, one or more of the components of the platform 500 may be embodied as circuitry or collection of electrical devices. Additionally, in some embodiments, one or more of the illustrative components may form a portion of another component and/or one or more of the illustrative components may be independent of one another.

The TEE 510 may be embodied as a trusted execution environment of the platform 500 that is authenticated and protected from unauthorized access using hardware support of the platform 500. The TEE 510 may also include or otherwise interface with one or more drivers, libraries, or other components of the platform 500 to interface with an accelerator.

Platform 500 also includes a NIC 520, which may be comparable to NIC 150 discussed above. In this embodiment, cryptographic engine 550 is included within platform 500. In one embodiment, cryptographic engine 550 is included within platform 500. In one embodiment, cryptographic engine 550 includes encryptor and decryptor logic that may be configured to perform a cryptographic operation associated with data transfer transactions (e.g., remote direct memory access (RDMA), Direct Memory Access (DMA), GPU, etc.).

As mentioned above, TDX comprise CPU instructions in a instruction set architecture (ISA) to isolate virtual machines (or trusted domains (TDs)) from a VMM and other TDs operating on a computing device. As a result, TDX removes the VMM from the TCB of the TD workloads. TDX IO extends the TDX architecture to allow a VMM outside the TCB to manage devices that can be securely assigned to a TD. TDX IO enables a device to be securely assigned to the TD such that data on an IO link is protected against confidentiality, integrity and replay attacks. TDX IO also enforces IOMMU properties such that a device may use direct memory access (DMA) directly to a TD's private memory once the TD accepted an interface for a measured device. Thus, two points of access control are configured on a CPU (or SoC) to ensure only accepted devices may access (e.g., read/write) into memory of a TD once the device has been attested successfully.

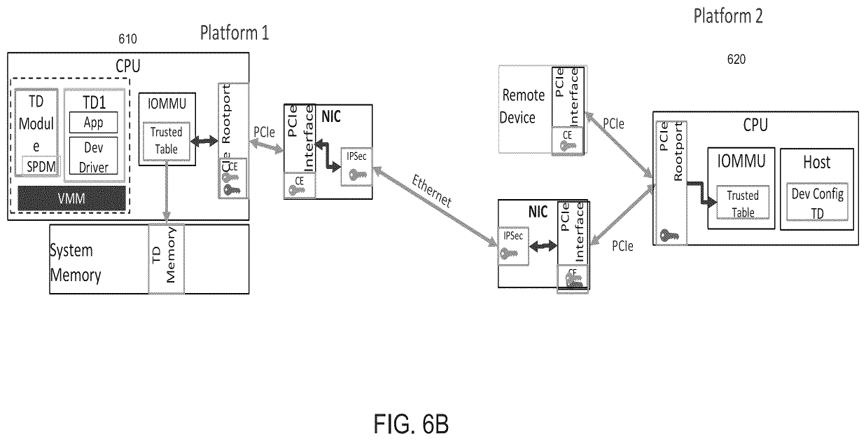

FIG. 6A illustrates a platform 610 implementing a conventional TDXIO access control of locally connected PCIe devices. As shown in FIG. 6A, a CPU SoC running a TD1 permits devices 1-3 access to access the private memory of TD1. Cryptographic access control is implemented in a rootport (e.g., integrated drive interface (IDE)—PCIe link encryption standard) to ensure that a PCIe packet is received from an authentic device, and not a spoofed device. IDE also protects against physical snooping or tampering of data on the PCIe link. A trusted page table within the IOMMU further checks whether the device has been allowed to access the private memory of the TD. Both access control processes use a PCIe device identifier (or PCIe Requester ID) for IDE key lookup and trusted page table lookup, which is a component of the PCIe Transaction Layer Packet (TLP) header. The integrity of TLP over the physical link is cryptographically protected per IDE standard, which ensures that the Requester ID has not been tampered or spoofed on the way from the device to the rootport on the SoC. Also, the requester ID is used for trusted page table lookup inside IOMMU before allowing the transaction to access TD's private memory.

To maximize utilization of devices, such as hardware accelerators (GPU, FPGA, etc.), in the data center, cloud services providers (CSPs) are enabling an application executed on one platform to use a device on another platform that may be idle. TDXIO does not efficiently operate in such a disaggregated compute model. For example, FIG. 6B illustrates a conventional solution to enable TDXIO to remote PCIe device coupled to another platform. As shown in FIG. 6B, a TD on Platform 610 (or 1) has to first interface with Platform 620 (or 2) to communicate securely with the Remote PCIe device that is connected to Platform 2. However, the current mechanism has limitations. Particularly, the IOMMU on Platform 1 has no way to apply the TDXIO access control to the remote device directly because the device read/write transactions occur over network protocol (e.g. Transmission Control Protocol/Internet Protocol (TCP-IP), RDMA packets, etc.). The rootport and IOMMU can apply an access check only if there is a Requester ID associated with the transaction, and the transaction has been protected using IDE.

TDXIO could be leveraged with the NIC to build an end to end secure tunnel that combines TDXIO with network security technologies such as Internet Protocol Security (IPsec). However this approach also has limitations. Specifically, there are multiple encrypts/decrypts in the path as shown in the picture above. Also, Platform 2 must have TDX and TDXIO (e.g. IDE support in the rootport on the CPU). Finally, both NICs must be included in TD1's TCB, thus considerably increasing the threat surface (e.g., the host is giving NIC access to read/write into TD's memory, not the Device).

According to one embodiment, ExpEther is implemented to enable PCIe tunneling over network. In such an embodiment, a remote PCIe device may be configured as a locally connected PCIe device with a PCIe Requester ID. Accordingly, PCIe link encryption (IDE) is extended to be tunneled over network protocols, which enables the standard TDXIO access controls that rely on Requester ID to be applied on the TD platform. As used herein, ExpEther is defined as a System Hardware Virtualization Technology that expands standard PCIE beyond having thousands of roots and endpoint devices together on a single network connected through the standard Ethernet. PCI Express-based software and hardware can be utilized using ExpEther without modification. ExpEther also provides software-defined re-configurability to make a disaggregated computing system with device-level. ExpEther enables a unique “PCI Express switch over Ethernet” architecture that distributes functional blocks of a PCI Express switch over Ethernet, maintaining a logical equivalency with the standard PCI Express switch.

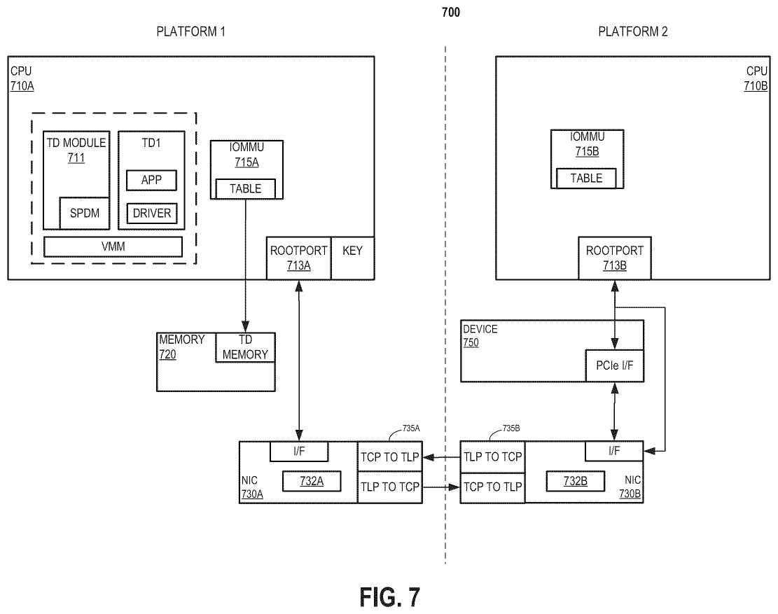

FIG. 7 illustrates one embodiment of a network 700 coupling Platform 1 and Platform 2, where Platform 1 is a local computing platform and platform 2 is a remote computing platform. As shown in FIG. 7, each platform includes a CPU SoC (or CPU) 710 (e.g., 710A and 710B). Similar to the architecture shown in FIG. 6B, both CPUs 710 include IOMMUs 715 (e.g., 715A and 715B) including trusted page tables, and rootports 713 (e.g., 713A and 713B). IOMMU 715A is implemented to access memory allocated to a TD (e.g., TD1) within memory 720. As used herein, a rootport is a port on the root complex, which is a portion of the CPU SoC that includes a host bridge. The host bridge enables PCI ports to communicate with other components of the platform, which allows components coupled to the PCI Express ports to operate with the platform. Accordingly, each rootport 713 is coupled to an NIC 730 (e.g., 713A and 713B) via an interface (e.g., PCIe interface) at the NIC 730. Additionally, rootport 713B is coupled to a remote IO device 750 via an interface at the device 750. Tunneling of PCIe via TCP/IP or RDMA is fully transparent to the PCIe root complex and operating system, where PCIe tunneling may occur over Ethernet, InfiniBand and other connectivity.

In one embodiment, NICs 730 comprise PCIe host interfaces 732 (e.g., 732A and 732B) that support PCIe a configuration bypass mode, which may be programmed for select PCIe devices identified by their requester ID, or for all PCIe devices. In such an embodiment, the bypass mode enables all Transaction Layer Packets (TLPs) to be received at the NIC 730 core (e.g., including config TLPs) for incoming PCIe packets received at an NIC 730 from a peer PCIe device or from the SoC rootport, and not terminated at the PCIe interface. In addition, the bypass mode enables outgoing PCIe packets from NIC 730 going to a peer PCIe device or to the rootport to inhibit the PCIe host interface from adding a PCIe TLP. Instead the host interface simply passes the received TLP as is over the network.

According to one embodiment, each NIC 730 includes a packet conversion module 735 (e.g., 735A and 735B). In such an embodiment, each packet conversion module 735 includes a TLP to TCP module to convert TLPs into TCP packets by encapsulating TLPs within TCP packets and a TCP to TLP module to convert TCP packets to TLPs by extracting (or stripping) a TCP layer to a TLP packet. In this embodiment, remote device 750 supports the security protocol and data model (SPDM) implemented at a TD module 711, integrity and data encryption (IDE) and other security capabilities specified by a TEE Device Interface Secure Protocol (TDISP) standard. SPDM defines messages, data objects, and sequences for performing message exchanges between devices over a variety of transport and physical media. The description of message exchanges includes authentication of hardware identities and measurement for firmware identities. The SPDM enables efficient access to low-level security capabilities and operations.

In a further embodiment, the PCIe host interface at device 750 may comprise a toggle to bypass IDE. In such an embodiment, IDE would be turned on and all PCIe read/writes would be protected if the device is assigned to platform 1. However, IDE may be turned off if the device is assigned to platform 2 (local platform), resulting in device 750 sending/receiving PCIe transactions without protection. In yet a further embodiment, one or more of the virtual functions (VFs) may be assigned to each of the platform if device 750 supports virtualization. In this embodiment, IDE includes additional modes in which it may selectively protect transactions for certain VFs that are assigned to TDs, such as TD1.

TDX/TDXIO do not have new requirements since the locality of device 750 is transparent to the rootport, IOMMU and the TD software. Additionally, there are no new security requirements for device 750 at platform 2 other than what may be implemented to enable device security per TDISP requirements. NIC 730A and 730B are not trusted entities and remain outside the trust boundary of TD1. Thus, the data flow external to rootport 713A is encrypted.

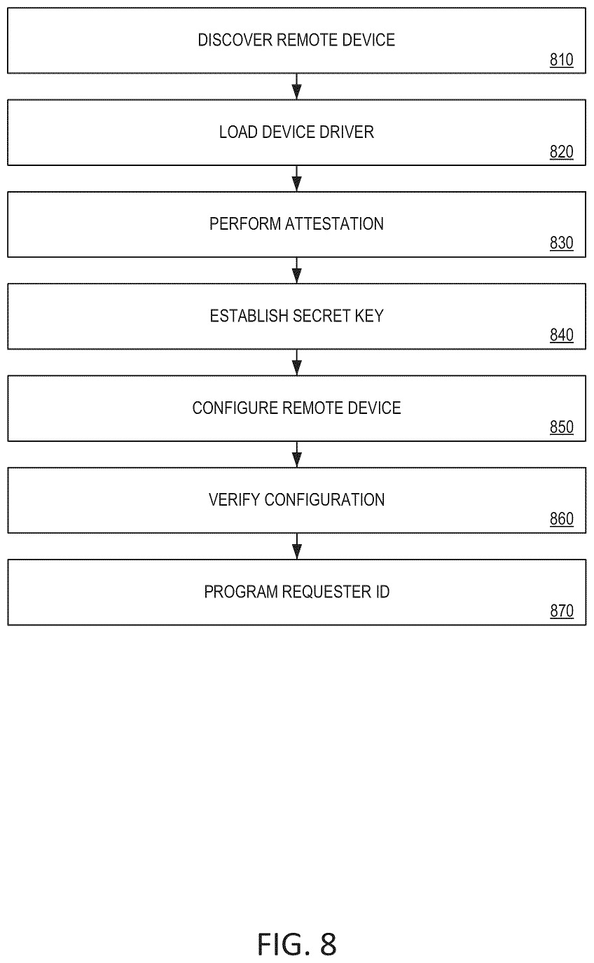

Prior to accessing device 750 at platform 2, CPU 710 performs secure device configuration to prepare it to bring it into TD's trust boundary. FIG. 8 is a flow diagram illustrating one embodiment of a secure data flow configuration process. At processing block 810, the VMM at CPU 710A discovers the remote device 750 as a PCIe connected device. At processing block 820, loads a device driver for TD1. In one embodiment, the VMM uses the mechanism that support PCIe device tunneling over network to discover device 750 and load the device driver.

At processing block 830, TD module 711 performs an attestation protocol (e.g., SPDM) with device 750. In one embodiment, messages are transmitted over the network as PCIe packets (TLPs) encapsulated in a network protocol (e.g., TCPIP or RDMA). This is transparent to the CPU hardware and software on platforms 1 and 2 and is transparently managed by the NIC 730A and 730B on the two platform. Upon determining that attestation is successful the TD Module and device 750 establish a shared secret key, processing block 840. In one embodiment, the TD Module derives an IDE key and programs the key into the PCIe rootport 713A, along with the Requester ID for key lookup. In such an embodiment, this key is used by the PCIe rootport to encrypt/decrypt transactions to/from that requester ID, which in this case is assigned to the remote device. Remote device 750 derives the same key and programs the key into its link encryption (IDE) crypto engine.

At processing block 850, TD1 transparently configures remote device 750 via MMIO over the network. At processing block 860, TD1 verifies the configuration over a secure tunnel using the SPDM key and locks the configuration. Device 750 enforces configuration locking as defined in TDISP standard. At processing block 870, TD1 programs the Requester ID associated with device 750 in the trusted page table in the IOMMU once the device is configured and locked in order to grant the device direct access to TD1's memory.

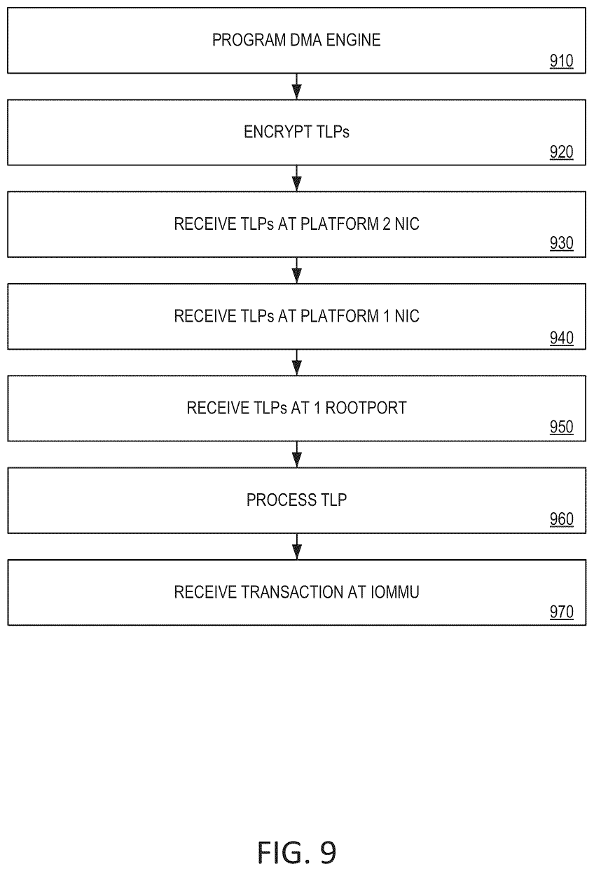

Once security configuration has been performed protected data flow between CPU 710A and device 750 may occur. FIG. 9 is a flow diagram illustrating one embodiment of a process to perform secure data flow. At processing block 910, TD1 programs a DMA engine at remote device 750 for data transfer. In one embodiment, MMIO messages to program the DMA engine with source and destination buffer are transmitted via TDXIO secure MMIO mechanisms that include security enforcements in IOMMU 715A, rootport 713A and within device 750. In such an embodiment, these messages are transmitted over the PCIe tunneled network.

At processing block 920, device 750 encrypts and integrity protects all TLPs originating from device 750 and transmitted to platform 1. In one embodiment, device 750 may use bypass mode and selectively encrypt PCIe packets (e.g., TLPs going over network are encrypted). However, the TLPs to Platform 2 may not be encrypted. In embodiments in which device 750 is a virtualization capable device where some virtual functions (VFs) are assigned to Platform 1 and some are assigned to platform 2, device 750 may use different IDE keys or may encrypt packets for VFs assigned to TDs and not for VFs assigned to regular VMs. Incoming TLPs from platform 1 is decrypted and authenticated.

At processing block 930, NIC 730B at platform 2 receives TLP packets in response to a memory transaction. In one embodiment, the host interface 732B uses the bypass mode for PCIe packets coming over PCIe link to not remove the TLP. Accordingly, the host interface simply adds a header for the network protocol (e.g., TCP-IP or RDMA). NIC 730B may use network security protocol to prevent network threats, though it is not required for protection of TD's data as it already has link encryption. At processing block 940, NIC 730A at Platform 1 receives the network packet. Subsequently, NIC 730A processes the packet and extracts the TLP. In one embodiment, the PCIe host interface at NIC 730A also has a bypass mode in which PCIe TLP is not added. In a further embodiment, the host interface does not have to perform encryption because the TLP received from remote device 750 has already been encrypted using the IDE key.

At processing block 950, the TLP is received at rootport 713A. At processing block 960, rootport 713A processes the TLP. In one embodiment, rootport 713A encrypts/decrypts transactions between CPU 710A and device 750. Further, rootport 713A performs key lookup based on the Requester ID that is included in the encrypted and integrity protected TLPs from device 150 to rootport 713A. Rootport 713A then looks up the IDE key using Requester ID as the index upon receiving the TLP. Subsequently, rootport 713A decrypts the packet and verifies authenticity. Rootport 713A removes the TLP layer. However, the Requester ID is carried along with the transaction. At processing block 970, IOMMU 715A receives the transaction and checks the trusted page table using the requester ID to determine whether device 750 is permitted to read/write into TD's memory and allows the transaction to go through if access is allowed.

Although discussed above with regards to secure tunneling of PCIe transactions between a TEE and remote PCIe device, other embodiments may implement protocols different than the above-described PCIe protocols. For example, the mechanism may also be applied to a remote compute express link (CXL) device. In such an embodiment, an NIC would include processing modules to preserve the CXL protocol over network such that IDE on CXL link carries over network links (e.g., ethernet, fiber, etc.). This would allow access control mechanisms on the TD platform to be applied to a remote CXL device same as to a local CXL device.

Illustrative examples of the technologies disclosed herein are provided below. An embodiment of the technologies may include any one or more, and any combination of, the examples described below.
Example 1 includes an apparatus comprising a memory device, a system on chip (SoC), including a central processing unit (CPU) to execute a virtual machine to retrieve data from the memory device and transmit the data to a remote input/output (I/O) device coupled to a remote computing platform as memory transaction data; and a port to transmit the memory transaction data as transaction layer packets (TLPs) and a network interface card (NIC) to receive the TLPs, including an interface to receive the TLPs and packet conversion hardware to convert the TLPs to network protocol packets and transmit the network protocol packets to the remote I/O memory device.
Example 2 includes the subject matter of Example 1, wherein the packet conversion hardware encapsulates the TLPs into the network protocol packets.
Example 3 includes the subject matter of any of Examples 1-2, wherein the NIC further comprises a host interface to operate in a bypass mode to enable the host interface to receive the TLPs and pass the TLPs to the packet conversion hardware.
Example 4 includes the subject matter of any of Examples 1-3, wherein the host interface adds a network protocol header to the TLPs and passes the TLPs and the header to the packet conversion hardware.
Example 5 includes the subject matter of any of Examples 1-4, wherein the NIC receives memory transaction data from the remote I/O device as network protocol packets.
Example 6 includes the subject matter of any of Examples 1-5, wherein the packet conversion hardware converts the network protocol packets to TLPs.
Example 7 includes the subject matter of any of Examples 1-6, wherein the interface transmits the TLPs to the port at the SoC.
Example 8 includes the subject matter of any of Examples 1-7, wherein SoC further comprises an input output memory management unit (IOMMU) including a page table.
Example 9 includes the subject matter of any of Examples 1-8, wherein the memory transaction data comprises a requester identifier associated with the remote I/O device and the port searches the page table within the IOMMU to determine whether the remote I/O device is authorized to access the memory.
Example 10 includes a method comprising receiving memory transaction data at a network interface controller (NIC) from a system on chip (SoC) port to be transmitted to a remote input/output (I/O) device coupled to a remote computing platform, wherein the memory transaction data comprises transaction layer packets (TLPs), converting the TLPs to network protocol packets and transmitting the network protocol packets to the remote I/O memory device.
Example 11 includes the subject matter of Example 10, wherein converting the TLPs to network protocol packets comprises encapsulating the TLPs into the network protocol packets.
Example 12 includes the subject matter of any of Examples 10-11, wherein the NIC adds a network protocol header to the TLPs prior to transmitting the network protocol packets to the remote I/O memory device.
Example 13 includes the subject matter of any of Examples 10-12, further comprising the NIC receiving memory transaction data from the remote I/O device as network protocol packets and converting the network protocol packets to the TLPs.
Example 14 includes the subject matter of any of Examples 10-13, wherein converting the network protocol packets to the TLPs comprises extracting the TLPs from the network protocol packets.
Example 15 includes the subject matter of any of Examples 10-14, further comprising transmitting the TLPs to the SoC port.
Example 16 includes at least one computer readable medium having instructions stored thereon, which when executed by one or more processors, cause the processors to receive memory transaction data from a system on chip (SoC) port to be transmitted to a remote input/output (I/O) device coupled to a remote computing platform, wherein the memory transaction data comprises transaction layer packets (TLPs), convert the TLPs to network protocol packets and transmit the network protocol packets to the remote I/O memory device.
Example 17 includes the subject matter of Example 16, wherein converting the TLPs to network protocol packets comprises encapsulating the TLPs into the network protocol packets.
Example 18 includes the subject matter of any of Examples 16-17, having instructions stored thereon, which when executed by one or more processors, further cause the processors to receive memory transaction data from the remote I/O device as network protocol packets and convert the network protocol packets to the TLPs.
Example 19 includes the subject matter of any of Examples 16-18, wherein converting the network protocol packets to the TLPs comprises extracting the TLPs from the network protocol packets.
Example 20 includes the subject matter of any of Examples 16-19, having instructions stored thereon, which when executed by one or more processors, further cause the processors to transmit the TLPs to the SoC port.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In addition, “a set of” includes one or more elements. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
a memory device,
a system on chip (SoC), including
a central processing unit (CPU) to execute a virtual machine to retrieve data from the memory device and transmit the data to a remote input/output (I/O) device coupled to a remote computing platform as memory transaction data; and
a port to transmit the memory transaction data as transaction layer packets (TLPs); and
a network interface card (NIC) to receive the TLPs, including:
an interface to receive the TLPs; and
packet conversion hardware to convert the TLPs to network protocol packets and transmit the network protocol packets to the remote I/O memory device.

2. The apparatus of claim 1, wherein the packet conversion hardware encapsulates the TLPs into the network protocol packets.

3. The apparatus of claim 1, wherein the NIC further comprises a host interface to operate in a bypass mode to enable the host interface to receive the TLPs and pass the TLPs to the packet conversion hardware.

4. The apparatus of claim 3, wherein the host interface adds a network protocol header to the TLPs and passes the TLPs and the header to the packet conversion hardware.

5. The apparatus of claim 1, wherein the NIC receives memory transaction data from the remote I/O device as network protocol packets.

6. The apparatus of claim 5, wherein the packet conversion hardware converts the network protocol packets to TLPs.

7. The apparatus of claim 6, wherein the interface transmits the TLPs to the port at the SoC.

8. The apparatus of claim 7, wherein SoC further comprises an input output memory management unit (IOMMU) including a page table.

9. The apparatus of claim 8, wherein the memory transaction data comprises a requester identifier associated with the remote I/O device and the port searches the page table within the IOMMU to determine whether the remote I/O device is authorized to access the memory.

10. A method comprising:
receiving memory transaction data at a network interface controller (NIC) from a system on chip (SoC) port to be transmitted to a remote input/output (I/O) device coupled to a remote computing platform, wherein the memory transaction data comprises transaction layer packets (TLPs);
converting the TLPs to network protocol packets; and
transmitting the network protocol packets to the remote I/O memory device.

11. The method of claim 10, wherein converting the TLPs to network protocol packets comprises encapsulating the TLPs into the network protocol packets.

12. The method of claim 11, wherein the NIC adds a network protocol header to the TLPs prior to transmitting the network protocol packets to the remote I/O memory device.

13. The method of claim 12, further comprising:
the NIC receiving memory transaction data from the remote I/O device as network protocol packets; and
converting the network protocol packets to the TLPs.

14. The method of claim 13, wherein converting the network protocol packets to the TLPs comprises extracting the TLPs from the network protocol packets.

15. The method of claim 13, further comprising transmitting the TLPs to the SoC port.

16. At least one computer readable medium having instructions stored thereon, which when executed by one or more processors, cause the processors to:
receive memory transaction data from a system on chip (SoC) port to be transmitted to a remote input/output (I/O) device coupled to a remote computing platform, wherein the memory transaction data comprises transaction layer packets (TLPs);
convert the TLPs to network protocol packets; and
transmit the network protocol packets to the remote I/O memory device.

17. The computer readable medium of claim of claim 16, wherein converting the TLPs to network protocol packets comprises encapsulating the TLPs into the network protocol packets.

18. The computer readable medium of claim of claim 16, having instructions stored thereon, which when executed by one or more processors, further cause the processors to:
receive memory transaction data from the remote I/O device as network protocol packets; and
convert the network protocol packets to the TLPs.

19. The computer readable medium of claim of claim 18, wherein converting the network protocol packets to the TLPs comprises extracting the TLPs from the network protocol packets.

20. The computer readable medium of claim of claim 19, having instructions stored thereon, which when executed by one or more processors, further cause the processors to transmit the TLPs to the SoC port.
